(19) United States
(12) Patent Application Publication
(10) Pub. No.: US 2026/0350163 A1
(43) Pub. Date: Nov. 5, 2026

(54) DETECTING CODE MODIFICATION OF RUNNING CODE MODULES

(71) Applicant: Assured Information Security, Inc., Rome, NY (US)

(72) Inventors: Adam Meily, Springboro, OH (US); Michael Brady Butler, Waldoboro, ME (US)

(73) Assignee: Assured Information Security, Inc., Rome, NY (US)

(21) Appl. No.: 19/194,288

(22) Filed: Apr. 30, 2025

(51) Int. Cl. G06F 21/56

(52) U.S. Cl. CPC G06F 21/565

(57) ABSTRACT

Detecting modification of a code module includes identifying an in-memory code module that executes on a computer system based on loading a stored code module into system memory from a storage device, segmenting the in-memory and stored code modules into respective code segments, determining a respective byte probability distribution for each code segment based on byte values thereof, performing pairwise comparisons between the in-memory code segments and the stored code segments to provide a collection of code segment similarity scores, determining, based on the collection of code segment similarity scores, a code module similarity score as between the in-memory code module and the stored code module, and based on the code module similarity score, determining whether or not the in-memory code module represents a threshold level of modification relative to the stored code module.

### BACKGROUND

The execution of computer programs generally involves loading code modules from storage into system/working memory, for instance volatile memory such as random access memory (RAM). The loaded code is then fetched for execution by processing circuit(s) of the system. Loaded and running code modules in benign processes usually originate from a file on disk, for instance an executable/binary file. Some executable file formats, for instance the portable executable file format, contain the data and code that a code module needs to operate, and the file on disk represents a ground truth of what the code module should substantially resemble when loaded into in memory.

A common technique taken by malware to evade antivirus or endpoint detection and response (EDR) solutions is to modify code, for instance code modules of a legitimate running process, so that it is the legitimate process that performs malicious operations, rather than the malicious process itself.

### SUMMARY

Aspects described herein use stored code modules, for instance portable executable or other executable files stored on disk, as truths to identify potentially malicious code modifications. In examples, this involves comparing a running process's image in memory to its image on disk. Further aspects can account for even legitimate code alteration that sometimes occurs. During a process to load a code module into memory, both the layout of the file and values within various sections may be altered, and there may be legitimate, benign reasons for this alteration. Legitimate code alteration precludes the use of a naïve byte-for-byte check for similarity between the file on disk and the in-memory version of the code. Aspects can address these and other drawbacks of existing code modification detection approaches.

Shortcomings of the prior art are overcome and additional advantages are provided through the provision of a computer-implemented method. The method identifies an in-memory code module. The in-memory code module executes on a computer system based on loading a stored code module into system memory of the computer system from a storage device. The method also segments the in-memory code module into in-memory code segments and the stored code module into stored code segments. The method also determines, for each code segment of the in-memory code segments and the stored code segments, a respective byte probability distribution for the code segment based on byte values of the code segment. The byte probability distribution includes a distribution of probabilities of the byte values of the code segment. The process also performs pairwise comparisons between the in-memory code segments and the stored code segments to provide a collection of code segment similarity scores. Each comparison, of the pairwise comparisons, provides a respective code segment similarity score of the collection of code segment similarity scores, and includes comparing an in-memory code segment of the in-memory code segments to a corresponding stored code segment of the stored code segments based on the byte probability distribution for the in-memory code segment and the byte probability distribution for the stored code segment to provide the respective code segment similarity score. Additionally, the method determines, based on the collection of code segment similarity scores, a code module similarity score as between the in-memory code module and the stored code module, and, based on the code module similarity score, determines whether or not the in-memory code module represents a threshold level of modification relative to the stored code module.

In one or more embodiments, the comparing includes determining (i) a byte similarity score as between the in-memory code segment and the stored code segment and (ii) an opcode similarity score as between the in-memory code segment and the stored code segment, the byte similarity score and opcode similarity score being determined using the byte probability distribution for the in-memory code segment and the byte probability distribution for the stored code segment, where the respective segment similarity score is a function of the byte similarity score and the opcode similarity score. In one or more embodiments, the opcode similarity score is a weighted and normalized opcode similarity score determined as a function of: a weight value; an opcode similarity measure as between the in-memory code segment and stored code segment; and an opcode probability of the stored code segment; where the opcode similarity measure is a function of probabilities, of (i) the probabilities of the byte values of the in-memory code segment and (ii) the probabilities of the byte values of the stored code segment, that correspond to opcode values; and where the opcode probability of the stored code segment is a composite of each probability, of the probabilities of the byte values of the stored code segment, that corresponds to a respective opcode value. In one or more embodiments, the weight value is a first weight value and wherein the byte similarity score is a weighted and normalized byte similarity score determined as a function of: a second weight value; a byte similarity measure as between the in-memory code segment and stored code segment; and a complementary probability of the opcode probability of the stored code segment; where the byte similarity measure is a function of probabilities, of (i) the probabilities of the byte values of the in-memory code segment and (ii) the probabilities of the byte values of the stored code segment, that correspond to non-opcode values. In one or more embodiments, the first weight value is greater than or equal to the second weight value.

In one or more embodiments, the segmenting segments the in-memory code module and the stored code module each into n ordered segments, and wherein the pairwise comparisons include a comparison of an ith in-memory code segment to an ith code segment for each i=1 to n.

In one or more embodiments, the code module similarity score is taken to be a code segment similarity score, of the collection of segment similarity scores, representing a least-similar compared pair of code segments.

The varying embodiments presented herein may be separable/optional from each other.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIGS. 1A-1B and 2A-2B illustrate example code modules and segmentation thereof to facilitate aspects described herein;

FIG. 3 depicts an example process for detecting modification of a code module loaded into computer system memory, in accordance with aspects described herein; and

FIG. 4 depicts an example computing environment to incorporate and/or use aspects described herein.

### DETAILED DESCRIPTION

Aspects described herein relate to real-time memory scanning and analysis, for instance scanning and analysis of running code modules that are loaded in host memory (e.g., RAM). The scanning and analysis can detect and identify code regions of a module in host memory that reflect potentially malicious modifications relative to the module's original executable code of the on-disk executable file from which the module and its code regions were loaded into host memory. A running code module includes executable code, such as that of an executable file stored on disk, and the executable code may be loaded into host/system memory for execution. In some embodiments, disclosed aspects for code modification analysis can be incorporated into an advanced real-time memory scanning and analysis capability that detects and identifies various different indicators of compromise within the live memory of a target system, for instance different types of artifacts that are indicative of antivirus or EDR evasion on the host.

In a generalized embodiment of aspects described herein, two sections of code—also referred to interchangeably herein as ‘code sections’ or ‘code modules’—are compared. One of these, termed herein an ‘in-memory code module’, resides in system memory, for instance it was loaded into system memory, and executes on a computer system, also referred to herein as the host. The other—termed herein a ‘stored code module’—is stored on a storage device, such as a disk, for instance as an executable file. A process divides/segments these code modules into chunks (also referred to interchangeably herein as ‘code segments’ or just ‘segments’), and then considers pairs of code segments in similarity comparisons. A similarity comparison includes, for instance, comparison of a pair of code segments—one from the in-memory code module and one from the stored code module. The comparison examines the similarity between the segments in terms of their constituent bytes, including bytes that are, or are taken to be, opcodes, and other bytes in the segments. Different weights may be applied to weigh these different byte similarities. The similarity comparisons between pairs of segments of the modules produces a resulting collection of code segment similarity scores between the pairs of segments of the two code modules. The process determines, using that collection, an overall similarity score—referred to herein as a code module similarity score—as between the two code modules. In some examples, the code module similarity score is taken as the minimum code segment similarity score. In some further embodiments, if the code module similarity score is below some configurable similarity score threshold, then the process concludes that the code module in memory has undergone a threshold level of modification such that the loaded module is to be considered potentially or actually malicious.

As noted previously, code modification analysis of a code modification analyzer described herein can be incorporated into an antimalware solution that provides one or more real-time memory scanning and analysis capabilities. The antimalware solution can be extensible and support multiple different use cases and runtime environments. In some examples, the antimalware solution defines an Application Programming Interface (API) for enumerating a running process list. The information for this list could come from any of various available sources, examples of which include but are not necessarily limited to: (i) calling an operating system-provided API directly to get the running process list, (ii) communicating directly with a privileged agent or kernel module that manually walks the running process list, bypassing a potentially compromised operating system-provided API, or (iii) running from a hypervisor and walking the memory of the operating system (OS) virtual machine to build the running process list without any coordination from the OS itself. The running process list can then inform one or more processes for which to perform real-time memory scanning and analysis. In any event, extensibility of the antimalware solution can allow it to run on the host system itself or be adapted to run from a remote, isolated, or secure location, such as a hypervisor, kernel, or an external hardware platform such as a Peripheral Component Interconnect Express (PCIe) device using Direct Memory Access (DMA), for instance.

In situations of code modification, areas of code within memory have been modified significantly, or at least to some threshold amount or nature, relative to their on-disk origin. Code modifications can be indicative of malicious activity, for instance process and module hollowing where large code sections are replaced, and/or control flow hijacking, which is a more targeted attack and typically scoped to a limited number of (say, 5) targeted functions. Generally each loaded code module in benign processes will originate from an on-disk file that includes executable code. By ‘on-disk’ is meant stored on a storage device, which could be any of various types of storage devices, including non-volatile storage such as a flash-based or spinning disk/drive of the subject computer system or another system. A common AV/EDR evasion technique is for malware to modify the code of a legitimate running process so that the legitimate process performs malicious operations, rather than the malicious process that runs the malware itself performing the operations.

Aspects described herein utilize the file on disk, the ‘stored code module’, in identifying code modifications in a loaded (in-memory) code module by comparing the image residing in memory, as reflected by the in-memory code module, to its image on disk as reflected by the stored code module.

To accomplish this, the antimalware solution attempts to identify the origin location for each in-memory code module, accounting for and resolving filesystem redirection. An example of filesystem redirection performed by the Windows® line of operating systems offered by Microsoft Corporation of Redmond, Washington (and of which WINDOWS is a registered trademark) is WOW64 folder redirection for 32-bit applications. For example, the explorer.exe process of Windows OSs may depend on ws2_32.dll, which the antimalware solution can detect being loaded from C:\Windows\System32\ws2_32.dll.

With the origin location of an in-memory code module having been identified, the corresponding stored code module on disk is identified. Each stored code module on disk may possess one or more sections that contain executable code. In portable executable format files, different flag(s) can be used to describe different sections within the file, including the contents of each section. An antimalware solution incorporating a code modification analysis by way of a code modification analyzer described herein can parse this information to identify regions in memory that correspond to executable code within the code module.

One challenge when comparing on-disk files to their corresponding images in memory is that the operating system might perform legitimate changes when loading the file from disk into system memory. Examples of these changes include applying relocations for relocatable images and reconciling section alignment, which can be different on-disk as compared to in-memory. This means that the naïve approach of a byte-by-byte comparison between a code module's disk image (the stored code module) and memory image (in-memory code module) will likely not work. Additionally, since code comparison may be desired for a significant number of modules and processes in memory, and perhaps even all of them, a code comparison algorithm is to be sufficiently performant, otherwise memory analysis of an entire system will take too long.

To address various challenges of code comparison, aspects use n-gram-based code segment comparisons. The code modification analyzer can split each code module into segments and determine a respective byte probability distribution of each code segment, the byte probability distribution of a code segment also referred to herein as a ‘codeprint’ of/for the code segment. The codeprint for the code segment can be based on byte values of the code segment and include a distribution of probabilities of the byte values of the code segment. For instance, the ‘codeprint’ may be 1-gram vector of byte probabilities corresponding to various different bytes of the segment, with an entry indicating the probability that a byte within the code chunk is a common opcode of the relevant instruction set architecture, for instance the x86 hardware architecture. In some embodiments, codeprints are generated with a single linear pass over the memory of a process, which lends itself to fast and efficient generation.

Whether or not an opcode is considered ‘common’ for purposes of the opcode probability determination may be configurable. In one example, a list of common opcodes is created manually to include opcodes for operations that are fundamental to defining and calling functions and/or sufficiently commonly used, for instance with a probability or frequency of at least some threshold level. An example list of operations/instructions for which their opcodes may be considered common are as follows: add [addition operation], or [OR operation], adc [add with carry], sbb [subtract with borrow], and [AND operation], sub [subtraction operation], xor [exclusive OR], push [push on stack operation], pop [pop from stack operation], mov [move operation], lea [load effective address operation], ret [return operation], call [call procedure].

Once the codeprints are generated for the segments of the in-memory and stored code modules the code chunks are compared. In this aspect, pairwise comparisons are performed between the in-memory code segments and the stored code segments. This provides a collection of code segment similarity scores, where each comparison of the pairwise comparisons provides a respective code segment similarity score of the collection of code segment similarity scores. Each such comparison can be a comparison of a selected code segment of the in-memory code segments of the in-memory code module to a selected code segment of the stored code segments of the stored code module. Specifically, the comparison compares the in-memory code segment to a corresponding stored code segment based on their respective byte probability distributions—the byte probability distribution for the in-memory code segment and the byte probability distribution for the stored code segment—to provide a respective code segment similarity score for the pair of code segments.

In a particular embodiment, the comparison uses the Bhattacharyya coefficient, referring to a measure of the amount of overlap between the two distributions and thus providing a method for comparing the similarity of them. The coefficient can range between 0 and 1, inclusive, with a coefficient of 0 representing completely dissimilar distributions and a coefficient of 1 representing identical distributions.

From the collection of code segment similarity scores, a process determines a code module similarity score as between the in-memory code module and the stored code module. This represents an overall similarity score as between the stored code module and the in-memory code module.

In some examples, the overall similarity score is based on the minimum of the code segment similarity scores. In an example that uses the Bhattacharyya coefficient, a ‘similarity measure’ could be taken as the minimum Bhattacharyya coefficient resulting from the code segment comparisons. The minimum can be used in this context to be sensitive to a malicious process that targets a PE module with a large section and only applies a small modification. In other words, by taking the most dissimilar (least similar) pair of code segments, the code modification analyzer can detect both large and comparatively small changes within a code module. A final code module similarity score can be based on this similarity measurement, for instance by weighting (equally or unequally as desired) the Bhattacharyya coefficient-based similarity and an opcode similarity score as described below, and determining a result based on that weighting.

In a particular example, a code module similarity score result is determined as follows:
let disk_codeprints=calculate_disk_codeprints(path_to_module_file);
let memory_codeprints=calculate_memory_codeprints(module_in_memory);
let segment_similarities=calculate_segment_similarities(disk_codeprints, memory_codeprints);
let module_similarity_score=minimum(segment_similarities);

Based on the similarity between the code modules as reflected by the code module similarity score, the process determines whether or not the in-memory code module represents a threshold level of modification relative to the stored code module. If a configurable threshold level of modification has occurred, this could be a sign that the in-memory process is malicious. Thus, in some examples, a determination of at least a threshold level of modification is explicitly taken as an indication of that a potentially malicious modification has occurred. The in-memory process could be flagged as potentially malicious, possibly for further action such as quarantining and/or deeper inspection, as examples.

The code modification analyzer could also detect when code present in memory does not have a backing executable file on disk. The most common case in which a code module will exist in system memory but will not have a counterpart module stored on disk is when a process or module is trying to masquerade as a different process or module on disk to bypass EDR or perform memory resident execution (e.g., no origin file on disk). For example, in process hollowing, a benign process, such as explorer.exe, is launched, paused, and then has its entire module overwritten in memory with a malicious process to execute. This leads to code modules either not being present in memory at all or code modules having a different virtual size in memory, beyond the normal file and memory alignment reconciliation that the Windows® loader performs. In memory, the primary module can still appear as the benign explorer.exe, but the code modification analyzer can be used to detect that the code modules do not match the on-disk origin, and produce such a finding and alert a user.

Thus, in accordance with aspects described herein, a process is provided for code modification identification. The process identifies an in-memory code module, which executes on a computer system based on loading a stored code module into system memory of the computer system from a storage device. In some examples, the process correlates at least some of a running code module loaded into host memory of a host system to an executable code module on disk from which the running code module was loaded and determines to compare the two for similarity.

The process then proceeds with a similarity comparison by first segmenting the in-memory code module into segments (‘in-memory code segments’) and the stored code module into segments (‘stored code segments’). In examples, the segmenting segments the give code module into n ordered segments, or sequential chunks, where each segment/chunk is a sequence of bytes, for instance consecutive bytes of the code module.

After segmenting the code modules, the process determines, for each code segment of the in-memory code segments and the stored code segments, a respective byte probability distribution for the code segment based on byte values of the code segment. The byte probability distribution includes a distribution of probabilities of the byte values of the code segment. For each byte value within the chunk, there is a respective probability that any byte within that chunk is equal to that byte value. As a basic example, if the byte value ‘0b’ appears twice in the chunk that is 10 bytes long, the probability for byte value ‘0b’ is 2/10=2. A non-zero probability can thus be determined for each unique byte value in the chunk and added to a vector representing the probability distribution. Further, any number of zero-value probabilities can be added to the vector, the zero-value probabilities corresponding to byte values that do not appear in the chunk at all (this will be explained further below).

In addition, the codeprint-a vector in this example—can also include an opcode probability value to indicate the probability that any byte within the chunk has a value that is a common instruction opcode of the host system's instruction set architecture. This can be determined as the sum of the probabilities of any byte value discussed above that is a common opcode value. A list of such ‘common’ opcodes can be provided or ascertained using any desired approach.

The segmenting and probability distribution determination can be done for both of the code modules. Further, segments of the two modules can be correlated together to correlate the n^{th} segment of the in-memory code module to the n^{th} segment of stored code module for comparison to each other as described herein.

As noted previously, zero-value probabilities could be included in the probability distributions. This may be done to facilitate comparisons between code segments. For instance, in some examples, included in the codeprint of the i^{th} code segment of the in-memory code module is a zero-value probability for each byte that does not appear in the i^{th} code segment of the in-memory code module but does appear in the i^{th} code segment of the stored code module.

With the codeprints generated, the code segments of the two code modules are compared pairwise, for instance to compare each i^{th} code segment of the two modules with each other. The process therefore performs pairwise comparisons between the in-memory code segments and the stored code segments. The comparisons provide a collection of code segment similarity scores, with each comparison of the pairwise comparisons providing a respective code segment similarity score of the collection of code segment similarity scores.

In some embodiments, a comparison determines a byte similarity score as between the in-memory code segment and the stored code segment. The byte similarity score can be determined using the byte probability distributions for the in-memory code segment and stored code segment that are being compared. There are options for imparting weights, normalizations, or other adjustments in these comparisons, if desired. Additionally, in some embodiments, a comparison determines an opcode similarity score as between the in-memory code segment and the stored code segment, the opcode similarity score also being determined based on the respective probability distributions for the in-memory and stored code segments. In some embodiments, a code segment similarity score for two code segments being compared is a function, for instance a sum, of a byte similarity score as between the two code segments and the opcode similarity score as between the two code segments.

In yet further embodiments, the probability values of the respective byte probability distributions of the code segments being compared are used to determine, for the pair of code segments: (i) an unweighted byte similarity score as a function of the byte probabilities, from their probability distributions, of the byte values in the segments that are not common opcode values, and (ii) an unweighted opcode similarity score as a function of the byte probabilities, from the probability distributions from the two segments, of the byte values in those segments that are common opcode values.

The unweighted byte similarity and opcode similarity scores can then be used to determine a weighted opcode and byte similarity scores as a function of the unweighted similarity score, a complementary probability, and a selected weight value.

As an example, a weighted opcode similarity score is determined as a function of the unweighted opcode similarity score, an opcode probability, and a weight, for instance 0.5 as an example. In this manner, the opcode similarity score as between the code segments can be a weighted and normalized opcode similarity score determined as a function of (at least) the following items:
(i) a weight value, or ‘opcode weight’—an example is 0.5, though the weight could be higher or lower;
(ii) an opcode similarity measure as between the in-memory code segment and stored code segment—The opcode similarity measure may be a function of probabilities that correspond to opcode values. The probabilities can be those of (i) the probabilities of the byte values of the in-memory code segment and (ii) the probabilities of the byte values of the stored code segment, i.e. those that appear in the byte probability distributions for the two segments that correspond to opcode values;
an opcode probability of the stored code segment, also referred to herein as a ‘disk opcode probability’—This may be a composite (e.g., sum) of each probability, of the probabilities of the byte values of the stored code segment, that correspond to a respective opcode value

Further, a weighted byte similarity score is determined as a function of the unweighted byte similarity score, a disk byte probability (for instance a complementary probability: 1-disk opcode probability), and a selected weight. In this manner, the byte similarity score as between the code segments can be a weighted and normalized byte similarity score determined as a function of (at least) the following items:
a second weight value, or ‘byte weight value’ as contrasted to the opcode weight value above;
a byte similarity measure as between the in-memory code segment and stored code segment—This is similar to the opcode similarity measure but with non-opcode byte values. Thus, the byte similarity measure may be a function of probabilities that correspond to non-opcode values. The probabilities can be those of the probabilities of the byte values of the in-memory code segment and the probabilities of the byte values of the stored code segment, i.e. those that appear in the byte probability distributions for the two segments that correspond to non-opcode values;
a complementary probability of the opcode probability of the stored code segment, for instance 1—the opcode probability noted above.

In a particular example, the two weights mentioned above—a first weight for the opcode similarity and a second weight for the byte similarity—are set equal at 0.5, which equally weighs the opcode similarity and the byte similarity in the overall similarity calculation. These weights may be adjusted as desired. Since opcode bytes are expected to appear much less frequent in a code module than non-opcode bytes, weighting the opcode similarity at least as equal as the byte similarity serves to desirably increase/emphasize the impact of the opcode similarity score in the final similarity score determination. Thus, first weight value attached to the opcode similarity score can be at least that of the second weight value attached to the byte similarity score.

A function is used against the weighted opcode and bye similarity scores to determine an overall code segment similarity score for the pair of code segments. A basic example of such a function is to sum the results, i.e.: weighted byte similarity score+weighted opcode similarity score=overall code segment similarity score.

A respective overall code segment similarity score for each code segment comparison produces a collection of code segment similarity scores. This can be used to determine an overall similarity score, as the code module similarity score, between the two correlated code modules as a function of the collection of code segment similarity scores. In some examples, the code module similarity score is taken to be a code segment similarity score, of the collection of segment similarity scores, representing a least-similar compared pair of code segments, for instance the code segment similarity score that is the minimum of the collection.

As noted previously, the process can detect when code is present in memory but does not have a backing executable file on disk. This can be done by looking at how the executable is mapped into memory and comparing it against the executable metadata to determine what should be present. For example, a comparison discussed above can identify an executable code region in memory that does not map to any PE (or other file on disk) code section/module. In this case, this region in memory would be an executable section of code that is not contained in an original executable on disk and may therefore be considered potentially malicious.

Aspects described herein can scan host live memory in real-time, in contrast to some conventional approaches that scan disk or memory captures. Further, no code disassembly is needed, as aspect operate on raw bytes of code regions, whereas most solutions disassemble an entire code region or individual basic blocks to perform comparisons. In addition, aspects account for legitimate changes, for instance those introduced by the OS when a module is loaded from disk into memory and prepared for execution, provided through the flexibility of the probability distribution comparison described herein.

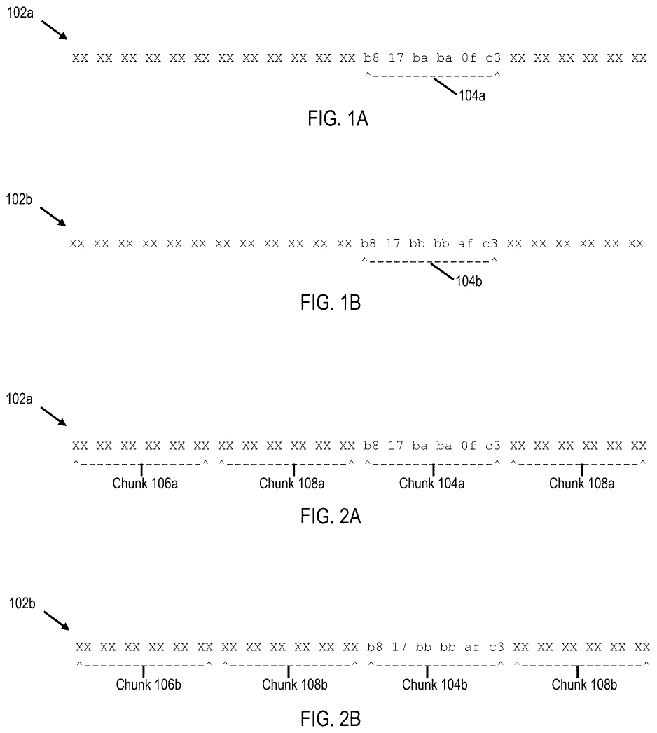

A detailed example with reference to FIGS. 1A-1B and 2A-2B is now provided to help illustrate aspects and principles described herein. FIG. 1A depicts at least a portion of an example code module 102a of a program on disk. The code module includes hexadecimal bytes (represented by XX). A six-byte region of interest 104a is denoted with the actual byte values of the six bytes, i.e., hexadecimal values b8, 17, ba, ba, 0f, and c2. Region 104a corresponds to what becomes a code segment (chunk) of code module 102a, as explained below. FIG. 1B depicts at least a portion of an example code module 102b as loaded into system memory (e.g., RAM). In this example, code module 102b is code module 102a loaded into memory but with a code modification applied. Code module 102b includes hexadecimal bytes (represented by XX), and a six-byte region of interest 104b is denoted with the actual byte values of the six bytes, i.e., values b8, 17, bb, bb, af, and c3. Region 104b corresponds to what will become a code segment (chunk) of code module 102b as explained below. It is seen that the 3^{rd}, 4^{th}, and 5^{th} bytes of the two regions 104a, 104b do not match. The mismatch is a result of code modification that was applied to the loaded code module 102b, either when loading stored code module 102a into memory or sometime after.

In accordance with aspects described herein, code modification detection splits/segments the on-disk and in-memory code modules into segments. This example uses a 6-byte segment size which segments the code modules into 6-byte sections. However, this is for illustrative purposes only; in practice, the segment size could be any desired size. In many practical embodiments, the segment size will be larger than six bytes.

FIG. 2A depicts the segmentation of stored code module 102a, which has been segmented into 6-byte segments/chunks—106a, 108a, 104a, and 110a. There are 24 bytes of code module 102a shown, and therefore the code segments shown are all equal length, though in practice this does not need to be the case. Similarly, FIG. 2B depicts the segmentation of in-memory code module 102b, which has been segmented into 6-byte segments/chunks—106b, 108b, 104b, and 110b. There are 24 bytes of code module 102b shown, and therefore the code segments shown are all equal length, though in practice this does not need to be the case.

The segmented code modules 102a and 102b are compared by comparing every i^{th} on-disk segment with the corresponding i^{th} in-memory segment to generate a code segment similarity score. This example will focus on the comparison of the third code segment shown for the two code modules, i.e., the comparison of stored code segment 104a to in-memory code segment 104b, and the comparisons of the other i^{th} code segments will be analogous to this example.

The comparison between segments includes a code segment similarity calculation that is based on byte probability calculations for the code segments. Table 1 below presents information about the bytes of the on-disk code segment 104a, specifically the offset of the byte from the beginning of the code segment, the binary value of the byte, the hexadecimal value of the byte, and an indication of the instruction/operation if the byte value corresponds to a common opcode of the particular instruction set architecture (such as the x86 instruction set architecture) for which the code modules are written:

TABLE 1

| Offset | Binary Value | Hex Value | Opcode |
|---|---|---|---|
| 0 | 1011 1000 | 0xb8 | mov eax |
| 1 | 0001 0111 | 0x17 | |
| 2 | 1011 1010 | 0xba | |
| 3 | 1011 1010 | 0xba | |
| 4 | 0000 1111 | 0x0f | |
| 5 | 1100 0011 | 0xc3 | ret |

The disassembly of the above is as follows:
mov eax, 0xfbaba17
ret

The on-disk code segment 104a therefore contains common instructions for a move and a return. Here, there is an instruction to move a 32-bit immediate value into the eax register. The code segment's virtual size when loaded into memory is 6 bytes.

A byte probability distribution (disk_distribution) for the on-disk code segment is determined based on the distribution of byte values in the segment and includes a collection of probabilities, each corresponding to a byte value. Here, the byte probability distribution is represented as follows:

```
disk_distribution = {
  0x0f: 0.1666,
  0x17: 0.1666,
  0xaf: 0.0000,
  0xb8: 0.1666,
  0xba: 0.3333,
  0xbb: 0.0000,
  0xc3: 0.1666
}
```

The above distribution includes a probability value for each of the five unique byte values of code segment 102a, and the probability value for each given byte value is determined as the number of times the value appears in the code segment divided by the total number of bytes in the segment. For instance, the byte probability for value 0xba is 2/6=0.3333 (truncated) because it appears twice in the 6 bytes of the segment, while the byte probability for each of the other byte values of the segment is 0.1666 (truncated) because each appears only once across in 6 bytes of the segment.

The distribution also includes zero-value probabilities (0.0000) for elided bytes. Elided bytes can be byte values that appear in a correlated code segment, for instance the correlated in-memory code segment 104b in this example. Code segment 104b has byte values 0xaf and 0xbb which do not appear in code segment 104a. Zero-value probabilities are therefore added into the distribution corresponding to code segment 104a. In some examples, zero-value probabilities can be added for other elided bytes.

The byte probability distribution can be presented as a vector of byte probabilities. In examples, a 1-gram probability vector is used and optionally includes a probability value corresponding to each possible byte value, for instance each value between 0 and decimal 255 (the unsigned values that can be represented by a single byte).

Thus, a probability value (byte probability) for a given byte value X in the code segment can be given as the probability that a random byte within the section will be X. Stated differently, it is the percentage of the bytes in the code segment that are that byte value X. As an example, a 256-item vector probabilities [ ] is created and initialized with floating point values of 0.0. Then, for i=0 to 255, probabilities [i] is set equal to (#bytes in code segment==i)/length (in bytes) of code segment. The sum of the probabilities in probabilities [i] will be 1.

An opcode probability of the code segment is also determined as the sum of the probabilities of the bytes that correspond to a common opcode. Using the example of on-disk code module 102a, instructions mov eax and ret correspond to common opcodes, and thus disk_opcode_probability=p(0xb8)+p(0xc3)=0.3333.

A byte probability distribution and opcode probability are also determined for in-memory code segment 102b, which has been modified to change the value of the 16-bit immediate that is moved into the eax register. Table 2 below presents information about the bytes of the in-memory code segment 104b, specifically the offset of the byte from the beginning of the code segment, the binary value of the byte, the hexadecimal value of the byte, and an indication of the instruction/operation if the byte value corresponds to a common opcode:

TABLE 2

| Offset | Binary Value | Hex Value | Opcode |
|---|---|---|---|
| 0 | 1011 1000 | 0xb8 | mov eax |
| 1 | 0001 0111 | 0x17 | |
| 2 | 1011 1011 | 0xbb | |
| 3 | 1011 1011 | 0xbb | |
| 4 | 1010 1111 | 0xaf | |
| 5 | 1100 0011 | 0xc3 | ret |

The disassembly of the above is as follows:
mov eax, 0xafbbbb17
ret

The byte probability distribution (mem_distribution) of the in-memory code segment, with elided byte values having probability 0.0000, is therefore represented as follows:

```
mem_distribution = {
  0x0f: 0.0000,
  0x17: 0.1666,
  0xaf: 0.1666,
  0xb8: 0.1666,
  0xba: 0.0000,
  0xbb: 0.3333,
  0xc3: 0.1666
}
```

The opcode probability of the in-memory code segment is the sum of the probabilities of the bytes making up instructions mov eax and ret, and thus mem_opcode_probability=p(0xb8)+p(0xc3)=0.3333, which is the same as the disk_opcode_probability.

The code segment similarity calculation proceeds by determining opcode and byte similarity scores. In some examples, these are weighted and normalized. Initially, an unweighted byte similarity measure and an unweighted opcode similarity measure are determined using the probabilities of the bytes of the code segments as follows:

```
byte_similarity measure = (
sqrt(disk_distribution[0x0f] * mem_distribution[0x0f]) +
sqrt(disk_distribution[0x17] * mem_distribution[0x17]) +
sqrt(disk_distribution[0xaf] * mem_distribution[0xaf]) +
sqrt(disk_distribution[0xba] * mem_distribution[0xba]) +
sqrt(disk_distribution[0xbb] * mem_distribution[0xbb])
)
opcode_similarity measure = (
  sqrt(disk_distribution[0xb8] * mem_distribution[0xb8]) +
  sqrt(disk_distribution[0xc3] * mem_distribution[0xc3])
)
```

Using the probabilities calculated above, the results are as follows:
byte_similarity measure=(0.0000+0.1666+0.0000+0.0000+0.0000)=0.1666
opcode_similarity measure=(0.1666+0.1666)=0.3333

The similar score as between the two code segments is determined by weighting (equally in this example, at 0.5 each) the byte similarity and opcode similarity measures, which are normalized using their respective total probabilities.

The following presents an example calculation for the weighted opcode similarity score using the opcode similarity measure: weighted_opcode_similarity score=(opcode_similarity measure/disk_opcode_probability)*weight_opcode_measure=(0.3333/0.3333)*0.5=0.50.

An example calculation for the weighted byte similarity score using the byte similarity measure is: weighted_byte_similarity score=(byte_similarity measure/(1.0−disk_opcode_probability))*weight_byte_measure=(0.1666/(1.0−0.3333))*0.5=(0.1666/0.6666)*0.5=0.1249. The term (1.0-disk_opcode_probability) in the above represents a complementary probability of the opcode probability of the stored code segment.

The code segment similarity score is determined as a function of the weighted byte similarity and opcode similarity scores determined above. In examples, the function is to take the sum of these scores, i.e., code segment similarity score=weighted_byte_similarity+weighted_opcode_similarity=0.5+0.1249=0.6249 in this example.

Once code segment similarity scores have been calculated for all compared code segments of the in-memory and stored code modules, a code module similarity score as between the in-memory code module and the stored code module is determined from this collection of code segment similarity scores. In examples, a function of the scores of the collection of code segment similarity scores is taken. In a specific example, the function is to take the minimum code segment similarity score of the collection: code_module_similarity score=min (code_segment_similarity 1, chunk_segment_similarity 2, . . . ).

Optionally, the code module similarity score is compared to a specified threshold designating the point at which the process considered the in-memory code module to have been modified in a manner inconsistent with standard, legitimate OS-based code modification. In some examples, exceeding the threshold-either above or below, depending on whether a higher lor lower score indicated more extensive modification—is taken to be an indication that the in-memory code module is potentially malicious and/or results from potentially malicious code modification.

In some embodiments, a code modification analyzer as described herein can run on a system to scan all running processes of a host system, or just a subset of the running processes as dictated by, command line filters based on process identifier and/or name, as examples. In any case, a process can build an output file, for instance in the JSON file format. The file can be presented on a console and/or saved to disk.

The code modification analyzer can optionally be part of an antimalware solution that is launched/deployed in any desired manner, for instance as part of a malware hunting and/or incident response framework as one example.

Additionally or alternatively, a code modification analyzer can be developed using any desired programming language or framework, an example of which is the Rust programming language, as a memory-safe, compiled, and performant language to improve stability when running on target systems.

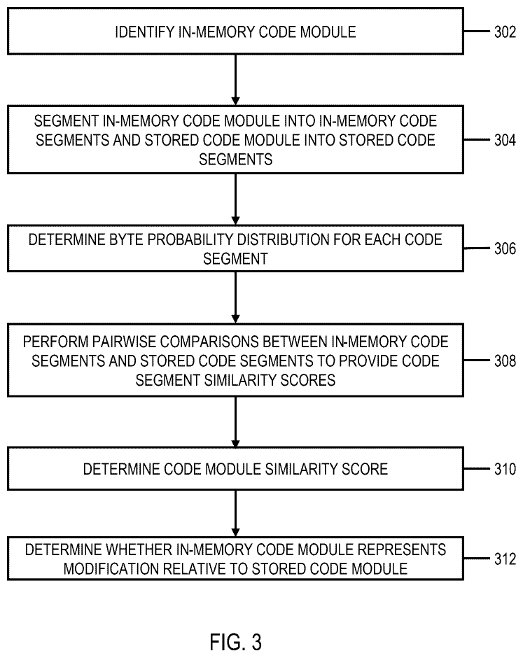

FIG. 3 depicts an example process for detecting modification of a code module loaded into computer system memory, in accordance with aspects described herein. The process may be executed, in one or more examples, by a processor or processing circuitry of one or more computers/computer systems, such as those described herein.

The process of FIG. 3 identifies (302) an in-memory code module. The in-memory code module is executing on a computer system based on loading a stored code module into system memory (also referred to as working memory) of the computer system from a storage device, also referred to as a disk. The process additionally segments (304) the in-memory code module into code segments, termed in-memory code segments herein, and segments the stored code module into code segments, termed stored code segments herein.

The process also determines (306), for each code segment of the in-memory code segments and the stored code segments, a respective byte probability distribution for the code segment, and this is based on byte values of the code segment. The byte probability distribution includes a distribution of probabilities of the byte values of the code segment. With the code modules segmented and the byte probability distributions determined, the process performs (308) pairwise comparisons between the in-memory code segments and the stored code segments. This provides a collection of code segment similarity scores, where each comparison, of the pairwise comparisons, provides a respective code segment similarity score of the collection of code segment similarity scores. Specific approaches for this comparison and similarity scoring are described herein.

In some examples, the segmenting at 304 segments the in-memory code module and the stored code module each into n ordered segments, and the pairwise comparisons include a comparison of an ith in-memory code segment to an ith code segment, for each i=1 to n.

Continuing with FIG. 3, the process determines (310), based on the collection of code segment similarity scores, a code module similarity score as between the in-memory code module and the stored code module, and, based on the code module similarity score, determines (314) whether or not the in-memory code module represents a threshold level of modification relative to the stored code module.

In embodiments, a pairwise comparison performed as part of 308 between the in-memory code segments and stored code segments includes comparing an in-memory code segment of the in-memory code segments to a corresponding stored code segment of the stored code segments based on the byte probability distribution for the in-memory code segment and the byte probability distribution for the stored code segment, to provide a respective code segment similarity score for the pairwise comparison between the two code segments. This pairwise comparing can include determining similarity scores as between the in-memory and stored code segments, for instance a byte similarity score and an opcode similarity score. The byte similarity score and opcode similarity score can be determined using the byte probability distribution for the in-memory code segment and the byte probability distribution for the stored code segment. The respective code segment similarity score for the pairwise comparison between the two code segments can be a function of the byte similarity score and the opcode similarity score, for instance a sum of the two scores in some examples.

The byte similarity score and/or opcode similarity score can optionally be determined based on weights, normalization, and/or other modifications.

For instance, the opcode similarity score can be a weighted and normalized opcode similarity score determined as a function of: (i) a weight value, (ii) an opcode similarity measure as between the in-memory code segment and stored code segment, and (ii) an opcode probability of the stored code segment.

The weight can be a first weight that complements a second weight applied in a byte similarity determination, discussed below.

The opcode similarity measure can be an indication of the similarity in opcodes present in the two compared code segments. In examples, this is determined as a Bhattacharyya coefficient. In general, the opcode similarity measure can be a function of probabilities, of (i) the probabilities of the byte values of the in-memory code segment and (ii) the probabilities of the byte values of the stored code segment, that correspond to opcode values.

The opcode probability of the stored code segment can be a composite (e.g., a sum) of each probability, of the probabilities of the byte values of the stored code segment, that corresponds to a respective opcode value.

The byte similarity score can also be a weighted and normalized byte similarity score. In examples, the byte similarity score is determined as a function of: (i) a weight value, (ii) a byte similarity measure as between the in-memory code segment and stored code segment, and (ii) a complementary probability of the opcode probability of the stored code segment.

The weight value here could be a second weight value that is the same as or different from a first weight value used in determining the opcode similarity score. In some examples, the first weight value is greater than or equal to the second weight value. The weight values provide the ability to control the impact of the two similarity scores in the overall code segment similarity score between the two compared segments.

The byte similarity measure can be a function of probabilities, of (i) the probabilities of the byte values of the in-memory code segment and (ii) the probabilities of the byte values of the stored code segment, that correspond to non-opcode values.

The complementary probability of the opcode probability can be determined as 1 minus the opcode probability of the stored code segment, or equivalently a composite (e.g., a sum) of each probability, of the probabilities of the byte values of the stored code segment, that do not correspond to respective opcode values.

In some examples, the code module similarity score is taken to be a code segment similarity score, of the collection of segment similarity scores, that represents a least-similar compared pair of code segments. For instance, if a lower similarity score indicates lower similarity, then the minimum code segment similarity score of the collection of code segment similarity scores can be taken as the code module similarity score.

Optionally, code modules observed in memory can be correlated to corresponding stored code modules to inform which specific code modules are to be compared for similarity. This can be used to avoid costly comparison of an observed in-memory code module to extraneous code modules, for instance every code module on the file system, which would likely be prohibitively resource-consuming. An example process for correlating code modules is as follows:

Enumerate the running processes of the system, for instance based on a list of executing processes of the computer system, and determining an on-disk location of a loaded data file containing executable code. Parse the loaded data file for code section descriptors that describe code sections of the loaded data file. There are, for example, structures within memory that contain metadata that can be used to identify locations from which loaded modules in memory originated from on disk. The parsing could, for instance enable the process to correlate a code module in a data link library file on disk (stored code module) to the in-memory code module. Based on the parsing, the process identifies the in-memory code module as corresponding to a described code section of a loaded data file, the described code section being the stored code module, and the correlating identifies the in-memory code module as originating from the stored code module of the loaded data file at the on-disk location.

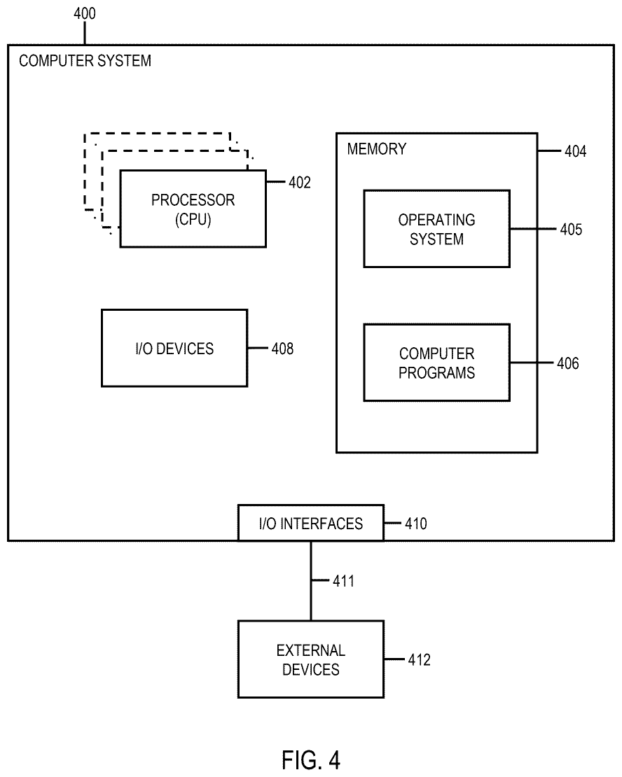

Processes described herein may be performed singly or collectively by one or more computer systems, such those described herein. FIG. 4 depicts one example of such a computer system and associated devices to incorporate and/or use aspects described herein. A computer system may also be referred to herein as a data processing device/system, computing device/system/node, or simply a computer. The computer system may be based on one or more of various system architectures and/or instruction set architectures, such as those offered by Intel Corporation (Santa Clara, California, USA) or ARM Holdings plc (Cambridge, England, United Kingdom), as examples.

FIG. 4 shows a computer system 400 in communication with external device(s) 412. Computer system 400 includes one or more processor(s) 402, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 402 can also include register(s) to be used by one or more of the functional components. Computer system 400 also includes memory 404, input/output (I/O) devices 408, and I/O interfaces 410, which may be coupled to processor(s) 402 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 404 can be or include main or system memory (e.g. Random Access Memory) used in the execution of program instructions, storage device(s) such as hard drive(s), flash media, or optical media as examples, and/or cache memory, as examples. Memory 404 can include, for instance, a cache, such as a shared cache, which may be coupled to local caches (examples include L1 cache, L2 cache, etc.) of processor(s) 402. Additionally, memory 404 may be or include at least one computer program product having a set (e.g., at least one) of program modules, instructions, code or the like that is/are configured to carry out functions of embodiments described herein when executed by one or more processors.

Memory 404 can store an operating system 405 and other computer programs 406, such as one or more computer programs/applications that execute to perform aspects described herein. Specifically, programs/applications can include computer readable program instructions that may be configured to carry out functions of embodiments of aspects described herein.

Examples of I/O devices 408 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (412) coupled to the computer system through one or more I/O interfaces 410.

Computer system 400 may communicate with one or more external devices 412 via one or more I/O interfaces 410. Example external devices include a keyboard, a pointing device, a display, and/or any other devices that enable a user to interact with computer system 400. Other example external devices include any device that enables computer system 400 to communicate with one or more other computing systems or peripheral devices such as a printer. A network interface/adapter is an example I/O interface that enables computer system 400 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Washington, U.S.A.).

The communication between I/O interfaces 410 and external devices 412 can occur across wired and/or wireless communications link(s) 411, such as Ethernet-based wired or wireless connections. Example wireless connections include cellular, Wi-Fi, Bluetooth®, proximity-based, near-field, or other types of wireless connections. More generally, communications link(s) 411 may be any appropriate wireless and/or wired communication link(s) for communicating data.

Particular external device(s) 412 may include one or more data storage devices, which may store one or more programs, one or more computer readable program instructions, and/or data, etc. Computer system 400 may include and/or be coupled to and in communication with (e.g. as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer system 400 may be operational with numerous other general purpose or special purpose computing system environments or configurations. Computer system 400 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

The computing environment described above with respect to FIG. 4 is only one example of a computing environment to incorporate, perform, and/or use aspect(s) of the present disclosure. Other examples are possible. For instance, in one or more embodiments, one or more of the components/modules of FIG. 4 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

Aspects of the present invention may be a system, a method, and/or a computer program product, any of which may be configured to perform or facilitate aspects described herein.

In some embodiments, aspects of the present invention may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc.

Program code can include one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
identifying an in-memory code module, the in-memory code module executing on a computer system based on loading a stored code module into system memory of the computer system from a storage device;
segmenting the in-memory code module into in-memory code segments and the stored code module into stored code segments;
determining, for each code segment of the in-memory code segments and the stored code segments, a respective byte probability distribution for the code segment based on byte values of the code segment, the byte probability distribution including a distribution of probabilities of the byte values of the code segment;
performing pairwise comparisons between the in-memory code segments and the stored code segments to provide a collection of code segment similarity scores, wherein each comparison, of the pairwise comparisons, provides a respective code segment similarity score of the collection of code segment similarity scores, and includes:
comparing an in-memory code segment of the in-memory code segments to a corresponding stored code segment of the stored code segments based on the byte probability distribution for the in-memory code segment and the byte probability distribution for the stored code segment to provide the respective code segment similarity score;
determining, based on the collection of code segment similarity scores, a code module similarity score as between the in-memory code module and the stored code module; and
based on the code module similarity score, determining whether or not the in-memory code module represents a threshold level of modification relative to the stored code module.

2. The method of claim 1, wherein the comparing includes determining (i) a byte similarity score as between the in-memory code segment and the stored code segment and (ii) an opcode similarity score as between the in-memory code segment and the stored code segment, the byte similarity score and opcode similarity score being determined using the byte probability distribution for the in-memory code segment and the byte probability distribution for the stored code segment, wherein the respective segment similarity score is a function of the byte similarity score and the opcode similarity score.

3. The method of claim 2, wherein the opcode similarity score is a weighted and normalized opcode similarity score determined as a function of:
a weight value;
an opcode similarity measure as between the in-memory code segment and stored code segment; and
an opcode probability of the stored code segment;
wherein the opcode similarity measure is a function of probabilities, of (i) the probabilities of the byte values of the in-memory code segment and (ii) the probabilities of the byte values of the stored code segment, that correspond to opcode values; and
wherein the opcode probability of the stored code segment is a composite of each probability, of the probabilities of the byte values of the stored code segment, that corresponds to a respective opcode value.

4. The method of claim 3, wherein the weight value is a first weight value and wherein the byte similarity score is a weighted and normalized byte similarity score determined as a function of:
a second weight value;
a byte similarity measure as between the in-memory code segment and stored code segment; and
a complementary probability of the opcode probability of the stored code segment;
wherein the byte similarity measure is a function of probabilities, of (i) the probabilities of the byte values of the in-memory code segment and (ii) the probabilities of the byte values of the stored code segment, that correspond to non-opcode values.

5. The method of claim 4, wherein the first weight value is greater than or equal to the second weight value.

6. The method of claim 1, wherein the segmenting segments the in-memory code module and the stored code module each into n ordered segments, and wherein the pairwise comparisons include a comparison of an ith in-memory code segment to an ith code segment for each i=1 to n.

7. The method of claim 1, wherein the code module similarity score is taken to be a code segment similarity score, of the collection of segment similarity scores, representing a least-similar compared pair of code segments.

8. A computer system comprising:
a memory; and
a processing circuit in communication with the memory, wherein the computer system is configured to perform a method comprising:
identifying an in-memory code module, the in-memory code module executing on a computer system based on loading a stored code module into system memory of the computer system from a storage device;
segmenting the in-memory code module into in-memory code segments and the stored code module into stored code segments;
determining, for each code segment of the in-memory code segments and the stored code segments, a respective byte probability distribution for the code segment based on byte values of the code segment, the byte probability distribution including a distribution of probabilities of the byte values of the code segment;
performing pairwise comparisons between the in-memory code segments and the stored code segments to provide a collection of code segment similarity scores, wherein each comparison, of the pairwise comparisons, provides a respective code segment similarity score of the collection of code segment similarity scores, and includes:
comparing an in-memory code segment of the in-memory code segments to a corresponding stored code segment of the stored code segments based on the byte probability distribution for the in-memory code segment and the byte probability distribution for the stored code segment to provide the respective code segment similarity score;
determining, based on the collection of code segment similarity scores, a code module similarity score as between the in-memory code module and the stored code module; and
based on the code module similarity score, determining whether or not the in-memory code module represents a threshold level of modification relative to the stored code module.

9. The computer system of claim 8, wherein the comparing includes determining (i) a byte similarity score as between the in-memory code segment and the stored code segment and (ii) an opcode similarity score as between the in-memory code segment and the stored code segment, the byte similarity score and opcode similarity score being determined using the byte probability distribution for the in-memory code segment and the byte probability distribution for the stored code segment, wherein the respective segment similarity score is a function of the byte similarity score and the opcode similarity score.

10. The computer system of claim 9, wherein the opcode similarity score is a weighted and normalized opcode similarity score determined as a function of:
a weight value;
an opcode similarity measure as between the in-memory code segment and stored code segment; and
an opcode probability of the stored code segment;
wherein the opcode similarity measure is a function of probabilities, of (i) the probabilities of the byte values of the in-memory code segment and (ii) the probabilities of the byte values of the stored code segment, that correspond to opcode values; and
wherein the opcode probability of the stored code segment is a composite of each probability, of the probabilities of the byte values of the stored code segment, that corresponds to a respective opcode value.

11. The computer system of claim 10, wherein the weight value is a first weight value and wherein the byte similarity score is a weighted and normalized byte similarity score determined as a function of:
a second weight value;
a byte similarity measure as between the in-memory code segment and stored code segment; and
a complementary probability of the opcode probability of the stored code segment;
wherein the byte similarity measure is a function of probabilities, of (i) the probabilities of the byte values of the in-memory code segment and (ii) the probabilities of the byte values of the stored code segment, that correspond to non-opcode values.

12. The computer system of claim 11, wherein the first weight value is greater than or equal to the second weight value.

13. The computer system of claim 8, wherein the segmenting segments the in-memory code module and the stored code module each into n ordered segments, and wherein the pairwise comparisons include a comparison of an ith in-memory code segment to an ith code segment for each i=1 to n.

14. The computer system of claim 8, wherein the code module similarity score is taken to be a code segment similarity score, of the collection of segment similarity scores, representing a least-similar compared pair of code segments.

15. A computer program product comprising:
a computer readable storage medium readable by a processing circuit and storing instructions for execution by the processing circuit to perform:
identifying an in-memory code module, the in-memory code module executing on a computer system based on loading a stored code module into system memory of the computer system from a storage device;
segmenting the in-memory code module into in-memory code segments and the stored code module into stored code segments;
determining, for each code segment of the in-memory code segments and the stored code segments, a respective byte probability distribution for the code segment based on byte values of the code segment, the byte probability distribution including a distribution of probabilities of the byte values of the code segment;
performing pairwise comparisons between the in-memory code segments and the stored code segments to provide a collection of code segment similarity scores, wherein each comparison, of the pairwise comparisons, provides a respective code segment similarity score of the collection of code segment similarity scores, and includes:
comparing an in-memory code segment of the in-memory code segments to a corresponding stored code segment of the stored code segments based on the byte probability distribution for the in-memory code segment and the byte probability distribution for the stored code segment to provide the respective code segment similarity score;
determining, based on the collection of code segment similarity scores, a code module similarity score as between the in-memory code module and the stored code module; and
based on the code module similarity score, determining whether or not the in-memory code module represents a threshold level of modification relative to the stored code module.

16. The computer program product of claim 15, wherein the comparing includes determining (i) a byte similarity score as between the in-memory code segment and the stored code segment and (ii) an opcode similarity score as between the in-memory code segment and the stored code segment, the byte similarity score and opcode similarity score being determined using the byte probability distribution for the in-memory code segment and the byte probability distribution for the stored code segment, wherein the respective segment similarity score is a function of the byte similarity score and the opcode similarity score.

17. The computer program product of claim 16, wherein the opcode similarity score is a weighted and normalized opcode similarity score determined as a function of:
a weight value;
an opcode similarity measure as between the in-memory code segment and stored code segment; and
an opcode probability of the stored code segment;
wherein the opcode similarity measure is a function of probabilities, of (i) the probabilities of the byte values of the in-memory code segment and (ii) the probabilities of the byte values of the stored code segment, that correspond to opcode values; and
wherein the opcode probability of the stored code segment is a composite of each probability, of the probabilities of the byte values of the stored code segment, that corresponds to a respective opcode value.

18. The computer program product of claim 17, wherein the weight value is a first weight value and wherein the byte similarity score is a weighted and normalized byte similarity score determined as a function of:
a second weight value;
a byte similarity measure as between the in-memory code segment and stored code segment; and
a complementary probability of the opcode probability of the stored code segment;
wherein the byte similarity measure is a function of probabilities, of (i) the probabilities of the byte values of the in-memory code segment and (ii) the probabilities of the byte values of the stored code segment, that correspond to non-opcode values.

19. The computer program product of claim 18, wherein the first weight value is greater than or equal to the second weight value.

20. The computer program product of claim 15, wherein the segmenting segments the in-memory code module and the stored code module each into n ordered segments, and wherein the pairwise comparisons include a comparison of an ith in-memory code segment to an ith code segment for each i=1 to n.

21. The computer program product of claim 15, wherein the code module similarity score is taken to be a code segment similarity score, of the collection of segment similarity scores, representing a least-similar compared pair of code segments.
